(19) United States
(12) Patent Application Publication
(10) Pub. No.: US 2023/0030558 A1
(43) Pub. Date: Feb. 2, 2023

(54) ELECTRONIC CONTROL UNIT, INFORMATION PROCESSING METHOD, AND NON-TRANSITORY STORAGE MEDIUM

(71) Applicants: TOYOTA JIDOSHA KABUSHIKI KAISHA, Toyota-shi (JP); LG ELECTRONICS INC., Seoul (KR)

(72) Inventors: Hisanori SHIBA, Toyota-shi (JP); Wonbo SHIM, Seoul (KR)

(73) Assignees: TOYOTA JIDOSHA KABUSHIKI KAISHA, Toyota-shi (JP); LG ELECTRONICS INC., Seoul (KR)

(21) Appl. No.: 17/871,269

(22) Filed: Jul. 22, 2022

(30) Foreign Application Priority Data
Jul. 28, 2021 (JP) 2021-123603

(51) Int. Cl. B60W 20/20; B60L 53/20

(52) U.S. Cl. CPC B60W 20/20; B60L 53/20

(57) ABSTRACT

An electronic control unit configured to be supplied with electric power from a battery in a vehicle includes a controller. The controller is configured to accumulate the operating time of the electronic control unit under a condition where a switch of a drive source of the vehicle is in an OFF state. The controller is configured to reset the electronic control unit when the elapsed time from a start point of accumulation of the operating time is less than a predetermined elapsed time, at a point in time when the cumulative operating time obtained by accumulating the operating time reaches a predetermined cumulative time.

### CROSS-REFERENCE TO RELATED APPLICATION

This application claims priority to Japanese Patent Application No. 2021-123603 filed on Jul. 28, 2021, incorporated herein by reference in its entirety.

### BACKGROUND

### 1. Technical Field

The disclosure relates to an electronic control unit, an information processing method, and a non-transitory storage medium.

### 2. Description of Related Art

Japanese Unexamined Patent Application Publication No. 2008-213782 (JP 2008-213782 A) discloses a technology related to resetting of an electronic control unit installed in a vehicle. When the electronic control unit described in JP 2008-213782 A is reset, a central processing unit (CPU) controls electric components of the vehicle, based on data indicating operating conditions of the electric components stored in an area different from a storage area used during normal operation.

### SUMMARY

This disclosure provides an electronic control unit, an information processing method, and a non-transitory storage medium that can reduce consumption of electric power of a battery due to abnormal operation of an electronic control unit installed in a vehicle.

An electronic control unit according to a first aspect of the disclosure is configured to be supplied with electric power from a battery in a vehicle. The electronic control unit includes a controller configured to accumulate an operating time of the electronic control unit under a condition where a switch of a drive source of the vehicle is in an OFF state, and reset the electronic control unit when an elapsed time from a start point of accumulation of the operating time is less than a predetermined elapsed time, at a point in time when a cumulative operating time obtained by accumulating the operating time reaches a predetermined cumulative time.

An information processing method according to a second aspect of the disclosure is executed by a computer. The information processing method includes accumulating an operating time of an electronic control unit configured to be supplied with electric power from a battery in the vehicle under a condition where a switch of a drive source of a vehicle is in an OFF state, and resetting the electronic control unit when an elapsed time from a start point of accumulation of the operating time is less than a predetermined elapsed time, at a point in time when a cumulative operating time obtained by accumulating the operating time reaches a predetermined cumulative time.

A non-transitory storage medium according to a third aspect of the disclosure stores instructions that are executable by a computer and causes the computer to perform functions. The functions includes accumulating an operating time of an electronic control unit configured to be supplied with electric power from a battery in the vehicle under a condition where a switch of a drive source of a vehicle is in an OFF state, and resetting the electronic control unit when an elapsed time from a start point of accumulation of the operating time of the electronic control unit is less than a predetermined elapsed time, at a point in time when a cumulative operating time obtained by accumulating the operating time reaches a predetermined cumulative time.

According to the disclosure, it is possible to reduce consumption of electric power of the battery due to abnormal operation of the electronic control unit installed in the vehicle.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a view schematically showing the configuration of a vehicle control system according to one embodiment;

FIG. 2 is a block diagram schematically showing one example of the functional configuration of an electronic control unit (ECU);

FIG. 3 is a time chart useful for describing the relationship between the cumulative operating time of the ECU and the time elapsed from a point in time when an IG switch is turned off; and

FIG. 4 is a flowchart illustrating the flow of information processing executed in the ECU.

### DETAILED DESCRIPTION OF EMBODIMENTS

An electronic control unit (which may be called “ECU”) according to the disclosure is a unit for controlling a vehicle. In the vehicle, electric power is supplied from a battery to the ECU. When a switch of a drive source of the vehicle is in the OFF state, operation of the ECU is also basically stopped. However, even under the condition where the switch of the drive source of the vehicle is OFF, the ECU is activated when a predetermined control condition is satisfied. At this time, too, the ECU operates with power supplied from the battery. Namely, the power of the battery is consumed when the ECU operates under the condition where the switch of the drive source of the vehicle is OFF.

If, however, the ECU is in normal condition, the amount of power consumed by operation of the ECU under the condition where the switch of the vehicle's drive source is OFF is relatively small. Thus, the phenomenon of excessive consumption of the battery power due to operation of the ECU is unlikely to occur. However, when the switch of the vehicle's drive source is in the OFF state, the ECU may be activated due to some malfunction or problem in the vehicle. If such abnormal operation of the ECU takes place, the power of the battery may be excessively consumed.

Thus, in the ECU according to the disclosure, the controller accumulates the operating time of the ECU under the condition where the switch of the vehicle's drive source is OFF. Furthermore, the controller determines whether the predetermined elapsed time has elapsed from a point in time when accumulation of the operating time of the ECU is started, at the time when the cumulative operating time of the ECU reaches the predetermined cumulative time. Here, the predetermined cumulative time and the predetermined elapsed time are threshold values used for determining whether the ECU is in abnormal operation. When the ECU is in abnormal operation, the cumulative operating time of the ECU reaches the predetermined cumulative time at an earlier point in time than that in the case where the ECU is in normal operation. Thus, the controller can determine that the ECU is in abnormal operation, when the cumulative operating time of the ECU under the condition where the switch of the vehicle's drive source is OFF reaches the predetermined cumulative time before the predetermined elapsed time elapses from the start point of accumulation of the ECU operating time.

Then, the controller resets the ECU when the elapsed time from the start point of accumulation of the ECU operating time is less than the predetermined elapsed time, at the time when the cumulative operating time of the ECU reaches the predetermined cumulative time. By resetting the ECU, it is possible to eliminate the malfunction that causes abnormal operation of the ECU. Namely, after the ECU restarts by resetting, abnormal operation of the ECU is less likely or unlikely to occur under the condition where the switch of the drive source of the vehicle is OFF. Therefore, it is possible to curb excessive power consumption of the battery of the vehicle due to abnormal operation of the ECU.

In the following, a specific embodiment of the disclosure will be described based on the drawings. The dimensions, materials, shapes, relative positions, etc. of components described in this embodiment are not intended to limit the technical scope of the disclosure to them alone, unless particularly stated otherwise.

### EMBODIMENT

System Overview

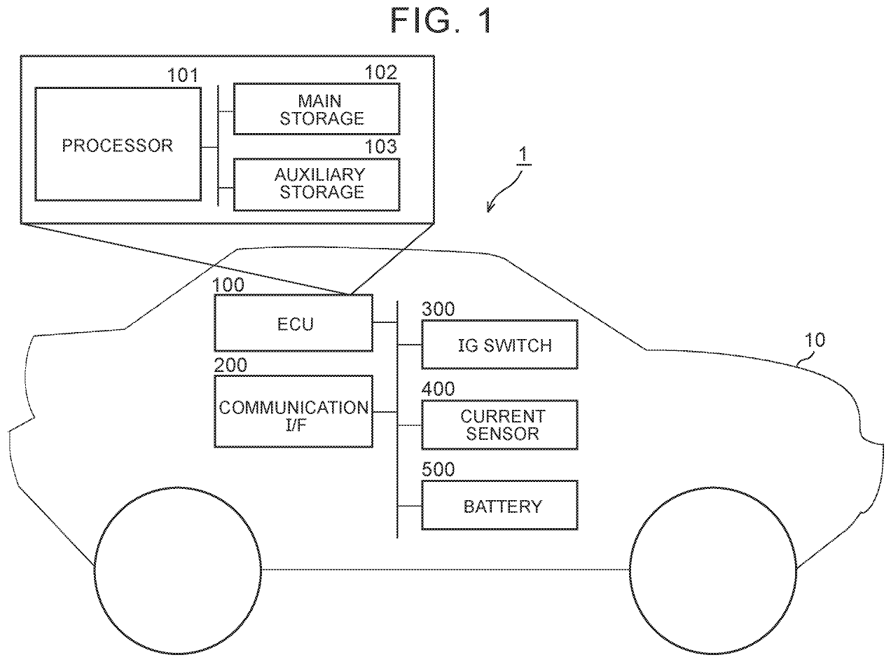

FIG. 1 schematically shows the configuration of a vehicle control system according to the embodiment. The vehicle control system 1 is a system for controlling a vehicle 10. The vehicle 10 has an internal combustion engine as a drive source. The vehicle control system 1 includes an electronic control unit (ECU) 100, communication interface (communication UF) 200, ignition switch (IG switch) 300, current sensor 400, and battery 500, which are installed in the vehicle 10.

The ECU 100 is one of a plurality of ECUs provided for controlling various devices in the vehicle 10. The ECU 100 is a computer having a processor 101, a main storage 102, and an auxiliary storage 103. The processor 101 is, for example, a central processing unit (CPU) or a digital signal processor (DSP). The main storage 102 is, for example, a random access memory (RAM). The auxiliary storage 103 is, for example, a read-only memory (ROM), hard disc drive (HDD), or flash memory. The auxiliary storage 103 may also include removable media (portable storage media). Here, the removable media are, for example, USB memory sticks, SD cards, or disc storage media such as CD-ROMs, DVD discs, or Blue-ray discs. The main storage 102 and the auxiliary storage 103 are examples of the storage in the disclosure.

The auxiliary storage 103 stores an operating system (OS), various programs, various information tables, and so forth. The processor 101 loads the programs stored in the auxiliary storage 103 into the main storage 102 and executes the programs, to implement various controls. However, some or all of the functions in the ECU 100 may be implemented by hardware circuits such as application specific integrated circuits (ASIC) or field programmable gate arrays (FPGA). In this connection, the ECU 100 is not necessarily required to be realized by a single physical configuration, but may be composed of two or more computers that are linked to each other. The ECU 100 may also be composed of two or more ECUs installed in the vehicle 10.

The communication I/F 200 is an interface where wireless communications are conducted between the vehicle 10 and devices outside the vehicle 10 (which may be simply referred to as “external devices”). Examples of the external devices include a user terminal carried by a user being outside the vehicle 10, a server device that monitors the status of the vehicle 10, etc. The communication I/F 200 includes a wireless communication circuit for wireless communications. The communication I/F 200 may communicate with the external devices via a network using a predetermined wireless communication standard. Examples of the predetermined wireless communication standard include 3G (3rd Generation), LTE (Long Term Evolution), 5G (5th Generation), etc. The communication I/F 200 may also communicate directly with the external devices using a predetermined short-range wireless communication standard. Examples of the predetermined short-range wireless communication standard include Bluetooth (registered trademark), Low Energy standard, WiFi (registered trademark), etc.

The IG switch 300 is used for starting or stopping the internal combustion engine of the vehicle 10. When the IG switch 300 is turned on, the internal combustion engine starts. When the IG switch 300 is turned off, the internal combustion engine stops.

The IG switch 300 is operated by the driver of the vehicle 10.

The current sensor 400 detects the current flowing in the ECU 100. The current sensor 400 detects the current value of the ECU 100 when the IG switch 300 is in the OFF state, as described below.

The battery 500 is an on-board battery that supplies electric power to various devices in the vehicle 10. The battery 500 may be a so-called auxiliary battery. The ECU 100 and the communication I/F 200 are supplied with power from the battery 500. Also, the battery 500 is charged while the internal combustion engine of the vehicle 10 is in operation.

In the vehicle control system 1, communications are performed between the communication I/F 200, IG switch 300, current sensor 400, and the ECU 100 via an in-vehicle network. In the in-vehicle network, communications are performed using a predetermined in-vehicle communication standard. Examples of the predetermined in-vehicle communication standard include CAN (Controller Area Network) and LIN (Local Interconnect Network).

The communication I/F 200 is controlled by the ECU 100. For example, the information received by the communication I/F 200 from the external devices is input to the ECU 100 via the in-vehicle network. Also, the information output from the ECU 100 is transmitted from the communication I/F 200 to the external devices via the in-vehicle network. Furthermore, a signal output from the IG switch 300 is input to the ECU 100 via the in-vehicle network. In this manner, the ECU 100 can obtain information concerning the ON or OFF state of the IG switch 300. Also, the detection value of the current sensor 400 is input to the ECU 100 via the in-vehicle network. The current sensor 400 may be provided in the ECU 100. In this case, the detection value of the current sensor 400 is directly input to the ECU 100.

In the vehicle control system 1, when the IG switch 300 is in the OFF state, operation of the ECU 100 is also basically stopped. However, even under a condition where the IG switch 300 is OFF, the ECU 100 operates when a predetermined control condition is satisfied. Examples of the predetermined control condition include an execution condition of communication with an external device via the communication I/F 200. More specifically, even under the condition where the IG switch 300 is OFF, the ECU 100 is automatically activated when it receives command information from a user terminal, or when it transmits information on the status of the vehicle 10 to a server device. At this time, too, the ECU 100 operates with power supplied from the battery 500.

In the vehicle control system 1, when the IG switch 300 is in the OFF state, the ECU 100 may be activated due to some malfunction or problem in the vehicle 10. For example, the ECU 100 may be activated when it receives, via the communication I/F 200, command information that activates the ECU 100, which normally should not be received. If such abnormal operation of the ECU 100 occurs under the condition where the IG switch 300 is OFF, the power in the battery 500 may be excessively consumed. Also, in the condition where the IG switch 300 is OFF, the battery 500 is not charged through operation of the internal combustion engine. Thus, excessive consumption of the power in the battery 500 may cause a so-called battery run-out. Thus, in the vehicle control system 1, resetting operation to reset the ECU 100 is performed so as to curb excessive consumption of the power in the battery 500. The resetting operation is operation to restart the ECU 100. Details of the procedure for executing resetting of the ECU 100 will be described later.

Functional Configuration

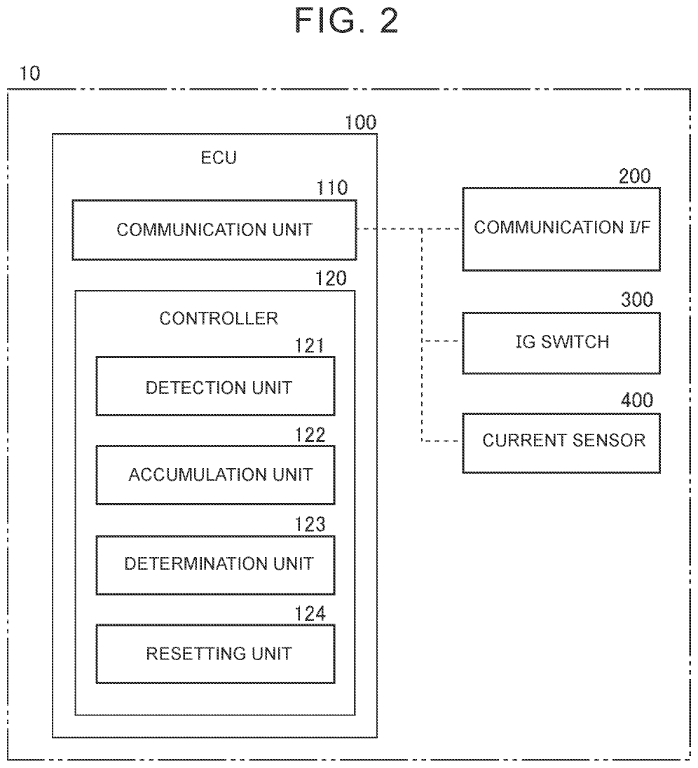

Next, the functional configuration of the ECU 100 that constitutes the vehicle control system 1 according to this embodiment will be described based on FIG. 2. FIG. 2 is a block diagram schematically showing the functional configuration of the ECU 100.

The ECU 100 has a communication unit 110 and a controller 120 as functional units. The communication unit 110 has the function of connecting the ECU 100 to the in-vehicle network. The ECU 100 communicates with the communication I/F 200, IG switch 300, and current sensor 400, using the communication unit 110.

The controller 120 has the function of performing arithmetic processing to control the ECU 100. The controller 120 can be realized by the processor 101. The controller 120 performs operation to send and receive information to and from the communication I/F 200 via the communication unit 110. The controller 120 also performs operation to receive a signal output from the IG switch 300, using the communication unit 110. The controller 120 also performs operation to receive the detection value of the current sensor 400, using the communication unit 110.

The controller 120 includes a detection unit 121, accumulation unit 122, determination unit 123, and resetting unit 124. When the ECU 100 is activated by power supplied from the battery 500, a current equal to or larger than a predetermined current value flows through the ECU 100. The detection unit 121 detects that the detection value of the current sensor 400 is equal to or larger than the predetermined current value when the IG switch 300 is in the OFF state.

The accumulation unit 122 accumulates the operating time of the ECU 100 under the condition where the IG switch 300 is OFF. Specifically, the accumulation unit 122 accumulates the time for which the detection value of the current sensor 400 is equal to or larger than the predetermined current value when the IG switch 300 is in the OFF state. The accumulation unit 122 starts accumulating the operating time of the ECU 100 from a point in time when the IG switch 300 is turned off, namely, when the internal combustion engine of the vehicle 10 is stopped. The operating time of the ECU 100 accumulated by the accumulation unit 122 includes not only the operating time measured when the ECU 100 is in abnormal operation, but also the operating time measured when the ECU 100 is in normal operation.

The determination unit 123 determines whether the ECU 100 needs to be reset when the cumulative operating time of the ECU 100 calculated by the accumulation unit 122 reaches a predetermined cumulative time. At this time, the determination unit 123 makes the determination, based on the time elapsed from the time when the IG switch 300 is turned off, which is measured at a point in time when the cumulative operating time of the ECU 100 reaches the predetermined cumulative time. As described above, the point in time when the IG switch 300 is turned off is the point in time when accumulation of the operating time of the ECU 100 by the accumulation unit 122 is started. Specifically, the determination unit 123 determines whether the elapsed time from the time when the IG switch 300 is turned off is less than a predetermined elapsed time, at the time when the cumulative operating time of the ECU 100 reaches the predetermined cumulative time. Then, when an affirmative decision (YES) is obtained by the determination unit 123, the resetting unit 124 performs operation to reset the ECU 100.

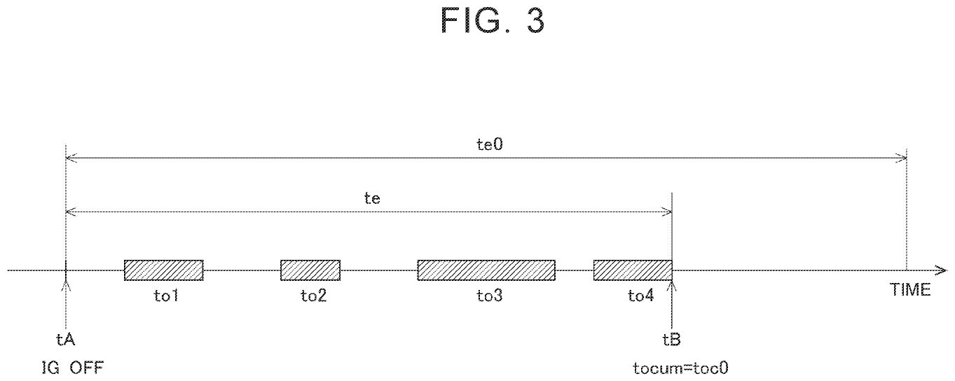

FIG. 3 is a time chart useful for describing the relationship between the cumulative operating time of the ECU 100 under the condition where the IG switch 300 is OFF, and the elapsed time from the time when the IG switch 300 is turned off. In FIG. 3, the IG switch 300 is switched from ON to OFF at time tA. Namely, in FIG. 3, the IG switch 300 is in the OFF state at and after time tA. In FIG. 3, each of the time periods to1, to2, to3, and to4 indicated by hatched areas indicates the period of time for which the detection value of the current sensor 400 is equal to or larger than the predetermined current value, namely, the operating time of the ECU 100. Accordingly, the sum of the time periods to1, to2, to3, and to4 is the cumulative operating time tocum of the ECU 100.

When the ECU 100 operates continuously, rather than operating intermittently as shown in FIG. 3, the continuous operating time of the ECU 100 is calculated as the cumulative operating time tocum of the ECU 100.

In FIG. 3, the cumulative operating time tocum of the ECU 100 reaches the predetermined cumulative time toc0 (e.g., two hours) at time tB. At this time, the period te from time tA to time tB is the elapsed time from the time when the IG switch 300 is turned off, which is measured at the time when the cumulative operating time tocum of the ECU 100 reaches the predetermined cumulative time toc0. In FIG. 3, the elapsed time te is less than the predetermined elapsed time te0 (e.g., six hours). Therefore, in the case illustrated in FIG. 3, the operation to reset the ECU 100 is performed by the resetting unit 124.

The predetermined cumulative time toc0 and the predetermined elapsed time te0 are threshold values used for determining whether the ECU 100 is in abnormal operation. When the ECU 100 is in abnormal operation, the operating time of the ECU 100 is prolonged, or the operation frequency of the ECU 100 rises, as compared with the time when the ECU 100 is in normal condition. Therefore, when abnormal operation occurs in the ECU 100, the cumulative operating time tocum of the ECU 100 reaches the predetermined cumulative time toc0 at an earlier point in time than that when the ECU 100 is in normal operation. Accordingly, when the cumulative operating time tocum of the ECU 100 reaches the predetermined cumulative time toc0 before the predetermined elapsed time te0 elapses from the point in time tA at which the IG switch 300 is turned off, it can be determined that the ECU 100 is in abnormal operation. In this connection, the predetermined cumulative time toc0 and the predetermined elapsed time te0 are set based on experiments, or the like, and stored in advance in the ECU 100.

In other words, when the predetermined elapsed time te0 or longer has elapsed from time tA at which the IG switch 300 is turned off, at the time when the cumulative operating time tocum of the ECU 100 reaches the predetermined cumulative time toc0, it can be determined that the ECU 100 is not in abnormal operation.

Information Processing

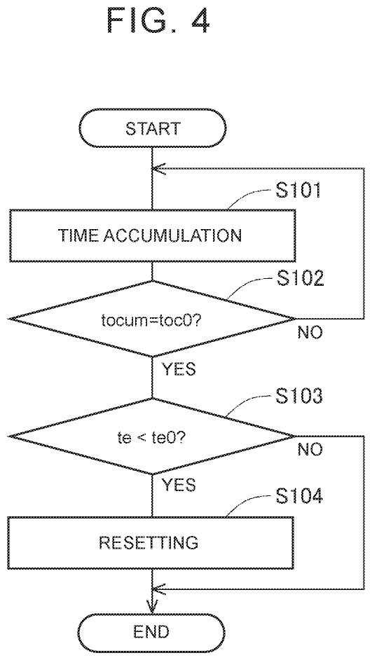

The information processing executed in the ECU 100 according to the embodiment will be described based on FIG. 4. FIG. 4 is a flowchart illustrating the flow of the information processing executed in the ECU 100. The flow is repeatedly executed by the controller 120 of the ECU 100 at predetermined intervals, when the ECU 100 is in operation under the condition where the IG switch 300 of the vehicle 10 is OFF. Namely, this flow is executed when the detection unit 121 in the controller 120 of the ECU 100 detects that the IG switch 300 of the vehicle 10 is in the OFF state and the detection value of the current sensor 400 is equal to or larger than the predetermined current value.

In this flow, first, in step S101, the period of time for which the IG switch 300 of the vehicle 10 is in the OFF state and the detection value of the current sensor 400 is equal to or larger than the predetermined current value is accumulated as the operating time of the ECU 100. The cumulative operating time tocum of the ECU 100 calculated in step S101 is stored in the main storage 102 of the ECU 100. The cumulative operating time tocum of the ECU 100 stored in the main storage 102 is updated each time step S101 is executed. When the ECU 100 operates intermittently, the operating time of the ECU 100 obtained this time is further accumulated with respect to the cumulative operating time tocum of the ECU 100 stored in the main storage 102 during the last operation of the ECU 100.

Then, in step S102, it is determined whether the cumulative operating time tocum of the ECU 100 calculated in step S101 reaches the predetermined cumulative time toc0. When a negative decision (NO) is obtained in step S102, step S101 is executed again. Namely, the operating time of the ECU 100 is further accumulated. On the other hand, when an affirmative decision (YES) is obtained in step S102, step S103 is executed next.

In step S103, it is determined whether the elapsed time te from the time when the IG switch 300 is turned off, which is measured at the time when cumulative operating time tocum of the ECU 100 reaches the predetermined cumulative time toc0, is less than the predetermined elapsed time te0. When a negative decision (NO) is obtained in step S103, namely, when the elapsed time te is equal to or longer than the predetermined elapsed time te0, execution of this flow is once finished. In this case, it can be determined that the ECU 100 is not in abnormal operation at the present time. Then, the cumulative operating time tocum of the ECU 100 up to the present time stored in the main storage 102 is reset once.

When an affirmative decision (YES) is obtained in step S103, it can be determined that the ECU 100 is in abnormal operation. Then, in step S104, the operation to reset the ECU 100 is performed. As a result, the ECU 100 is restarted. At this time, too, the cumulative operating time tocum of the ECU 100 up to the present time stored in the main storage 102 is reset as the resetting operation is performed. Then, execution of this flow is once finished.

In the vehicle control system according to this embodiment, when the ECU 100 is in abnormal operation when the IG switch 300 is in the OFF state, the operation to reset the ECU 100 is performed. With the ECU 100 thus reset, the problem that causes the abnormal operation of the ECU 100 can be eliminated. Namely, after the operation to reset the ECU 100 is performed to restart the ECU 100, abnormal operation of the ECU 100 is less likely or unlikely to occur under the condition where the IG switch 300 of the vehicle 10 is OFF. Thus, it is possible to curb excessive power consumption of the battery 500 of the vehicle 10 due to abnormal operation of the ECU 100. Consequently, battery run-out can also be curbed in the vehicle 10.

Modified Examples

As described above, in the flow of information processing shown in FIG. 4, when an affirmative decision (YES) is obtained in step S103, the cumulative operating time tocum of the ECU 100 up to the present time stored in the main storage 102 is once reset. At this time, if the IG switch 300 continues to be in the OFF state thereafter, the operating time of the ECU 100 (the time for which the detection value of the current sensor 400 is equal to or larger than the predetermined current value) may be accumulated again. Namely, the controller 120 may start accumulation of the operating time of the ECU 100 under the condition where the IG switch 300 is OFF, from the time when the operation to reset the ECU 100 is performed.

Then, when the cumulative operating time of the ECU 100 accumulated again reaches the predetermined cumulative time, it may be determined again whether the ECU 100 needs to be reset. At this time, the determination is made based on the elapsed time from a point in time when the ECU 100 is reset, namely, when the accumulation of the operating time of the ECU 100 is started again. Specifically, the controller 120 determines whether the elapsed time from the time when the ECU 100 is reset is less than the predetermined elapsed time, at the time when the cumulative operating time of the ECU 100 reaches the predetermined cumulative time. Then, when an affirmative decision (YES) is obtained in this determination, the controller 120 performs the operation to reset the ECU 100 again. With this configuration, even when abnormal operation occurs in the ECU 100 after the time when the predetermined elapsed time te0 elapses from the time when the IG switch 300 is turned off in the vehicle 10, excessive power consumption of the battery 500 can be curbed.

In the illustrated embodiment, the ECU 100 controls the communication OF 200. However, the ECU according to this disclosure may control other devices in the vehicle.

In the illustrated embodiment, the vehicle 10 has the internal combustion engine as the drive source. However, the vehicle according to this disclosure may be a battery electric vehicle having an electric motor as a drive source. In the battery electric vehicle, the electric motor starts when a power switch is turned on. In the battery electric vehicle, the electric motor stops when the power switch is turned off. Then, in the battery electric vehicle, the ECU accumulates the operating time of the ECU under a condition where the power switch is OFF. Namely, accumulation of the operating time of the ECU is started from a point in time when the power switch is turned off, namely, when the electric motor of the vehicle is stopped. The vehicle according to this disclosure may be a hybrid electric vehicle having both an internal combustion engine and an electric motor as drive sources.

Other Embodiments

The above embodiment is a mere example, and the disclosure may be changed as needed and implemented without departing from the principle thereof. The processes and means described in the disclosure may be combined freely and implemented as long as there is no technical inconsistency.

Any process described as being performed by one device may be shared and performed by two or more devices. Or, any process described as being performed by difference devices may be performed by one device. In a computer system, it is possible to flexibly change what hardware configuration (server configuration) is used to implement each function.

The disclosure may also be realized by supplying a computer program implementing the functions described in the above embodiment to a computer, and causing one or more processors of the computer to read and execute the computer program. The computer program may be provided to the computer via a non-transitory computer-readable storage medium that can be connected to a system bus of the computer, or may be provided to the computer via a network. The non-transitory computer-readable storage medium may be selected from, for example, any type of discs such as magnetic discs (floppy (registered trademark) disc, hard disc drive (HDD), etc.) and optical discs (CD-ROM, DVD disc, Blue-ray disc, etc.), read-only memory (ROM), random access memory (RAM), erasable programmable read-only memory (EPROM), electrically erasable programmable read-only memory (EEPROM), magnetic card, flash memory, and any type of media, such as an optical card, suitable for storing electronic instructions.

What is claimed is:

1. An electronic control unit configured to be supplied with electric power from a battery in a vehicle, the electronic control unit comprising a controller configured to:
accumulate an operating time of the electronic control unit under a condition where a switch of a drive source of the vehicle is in an OFF state; and
reset the electronic control unit when an elapsed time from a start point of accumulation of the operating time is less than a predetermined elapsed time, at a point in time when a cumulative operating time obtained by accumulating the operating time reaches a predetermined cumulative time.

2. The electronic control unit according to claim 1, wherein the controller is configured to start accumulating the operating time from a point in time when the switch of the drive source of the vehicle is turned off.

3. The electronic control unit according to claim 1, wherein the controller is configured to accumulate a period of time for which a current value of the electronic control unit is equal to or larger than a predetermined current value when the switch of the drive source of the vehicle is in the OFF state, as the operating time.

4. The electronic control unit according to claim 3, wherein the controller is configured to obtain a detection value of a current sensor configured to detect a current flowing in the electronic control unit.

5. The electronic control unit according to claim 1, further comprising a storage configured to temporarily store the cumulative operating time calculated by the controller.

6. The electronic control unit according to claim 5, wherein the controller is configured to reset the cumulative operating time stored by the storage when the electronic control unit is reset.

7. The electronic control unit according to claim 1, wherein:
the vehicle includes an internal combustion engine as the drive source; and
the switch of the drive source is an ignition switch.

8. The electronic control unit according to claim 7, wherein the battery is configured to be charged through operation of the internal combustion engine.

9. The electronic control unit according to claim 1, wherein:
the vehicle includes an electric motor as the drive source; and
the switch of the drive source is a power switch of the electric motor.

10. The electronic control unit according to claim 1, wherein the electronic control unit is configured to control a communication interface that is installed in the vehicle and performs wireless communication with an outside of the vehicle.

11. An information processing method executed by a computer, the information processing method comprising:
accumulating an operating time of an electronic control unit under a condition where a switch of a drive source of a vehicle is in an OFF state, the electronic control unit being configured to be supplied with electric power from a battery in the vehicle; and
resetting the electronic control unit when an elapsed time from a start point of accumulation of the operating time is less than a predetermined elapsed time, at a point in time when a cumulative operating time obtained by accumulating the operating time reaches a predetermined cumulative time.

12. The information processing method according to claim 11, wherein in the accumulating, the accumulation of the operating time is started from a point in time when the switch of the drive source of the vehicle is turned off.

13. The information processing method according to claim 11, wherein in the accumulating, a period of time for which a current value of the electronic control unit is equal to or larger than a predetermined current value when the switch of the drive source of the vehicle is in the OFF state is accumulated as the operating time.

14. The information processing method according to claim 13, further comprising obtaining a detection value of a current sensor configured to detect a current flowing in the electronic control unit.

15. The information processing method according to claim 11, wherein in the resetting, the cumulative operating time temporarily stored in a storage of the electronic control unit is reset when the electronic control unit is reset.

16. The information processing method according to claim 11, wherein:
the vehicle includes an internal combustion engine as the drive source; and
the switch of the drive source is an ignition switch.

17. The information processing method according to claim 11, wherein:
the vehicle includes an electric motor as the drive source; and
the switch of the drive source is a power switch of the electric motor.

18. A non-transitory storage medium storing instructions that are executable by a computer and that cause the computer to perform functions comprising:
accumulating an operating time of an electronic control unit under a condition where a switch of a drive source of a vehicle is in an OFF state, the electronic control unit being configured to be supplied with electric power from a battery in the vehicle; and
resetting the electronic control unit when an elapsed time from a start point of accumulation of the operating time of the electronic control unit is less than a predetermined elapsed time, at a point in time when a cumulative operating time obtained by accumulating the operating time reaches a predetermined cumulative time.

19. The non-transitory storage medium according to claim 18, wherein in the accumulating, accumulating the operating time is started from a point in time when the switch of the drive source of the vehicle is turned off.

20. The non-transitory storage medium according to claim 18, wherein in the accumulating, a period of time for which a current value of the electronic control unit is equal to or larger than a predetermined current value is accumulated as the operating time when the switch of the drive source of the vehicle is in the OFF state.
